(19) United States
(12) Patent Application Publication
(10) Pub. No.: US 2018/0253500 A1
(43) Pub. Date: Sep. 6, 2018

(54) Visual Mapping of Device Alerts

(71) Applicant: DELL PRODUCTS, LP, Round Rock, TX (US)

(72) Inventors: Alok Ranjan, Bangalore (IN); Chaitanya Aggarwal, Faridabad (IN)

(21) Appl. No.: 15/449,628

(22) Filed: Mar. 3, 2017

(51) Int. Cl. G06F 17/30; H04L 12/24; H04L 12/26; G06F 17/22; G06F 17/50

(52) U.S. Cl. CPC G06F 17/30867; H04L 41/145; G06F 17/5009; H04L 43/045; G06F 17/2247; H04L 43/065

(57) ABSTRACT

A chassis map provides a virtual simulation of internal components operating in an information handling system. Any component operating within the information handling system is represented with an image and displayed according to physical location within a chassis. Moreover, the chassis map is web-based, thus providing a generic or agnostic solution that does not depend on hardware or software capabilities. Any device may download the chassis map using a software plugin or web-based application. The chassis map generates a complete and holistic representation of the information handling system, thus simplifying diagnostics and maintenance efforts.

### CROSS-REFERENCE TO RELATED APPLICATION

Related subject matter is contained in co-pending U.S. patent application Ser. No. 15/______ entitled “Web-Based Network Topology Viewer,” filed of even date herewith, the disclosure of which is hereby incorporated by reference.

### FIELD OF THE DISCLOSURE

The present disclosure generally relates to information handling systems, and more particularly relates to visual mapping of device alerts.

### BACKGROUND

As the value and use of information continues to increase, individuals and businesses seek additional ways to process and store information. One option is an information handling system. An information handling system generally processes, compiles, stores, or communicates information or data for business, personal, or other purposes. Technology and information handling needs and requirements can vary between different applications. Thus information handling systems can also vary regarding what information is handled, how the information is handled, how much information is processed, stored, or communicated, and how quickly and efficiently the information can be processed, stored, or communicated. The variations in information handling systems allow information handling systems to be general or configured for a specific user or specific use such as financial transaction processing, airline reservations, enterprise data storage, or global communications. In addition, information handling systems can include a variety of hardware and software resources that can be configured to process, store, and communicate information and can include one or more computer systems, graphics interface systems, data storage systems, networking systems, and mobile communication systems. Information handling systems can also implement various virtualized architectures. Data and voice communications among information handling systems may be via networks that are wired, wireless, or some combination.

### SUMMARY

Networks and devices are often too complex to diagnose. A typical business network may connect hundreds of diverse devices of different manufactures, different types, and different configurations. Even residential networks connect many diverse devices. Should any networked device develop a problem, diagnosis and repair is very difficult. Even though messages and alerts may be generated, these messages and alerts are conventionally displayed as text, which is complicated to decipher.

Exemplary embodiments provide visual alerts. Whenever a notification is generated, exemplary embodiments may visually map the notification to a chassis component generating the notification. Exemplary embodiments thus generate a chassis map that visually illustrates a computer chassis (or other device) and its internal components. Exemplary embodiments may overlay a notification message onto a digital image of the internal component generating the notification message. The chassis map thus collects any messages generated by an internal component and virtually displays an image of the internal component with its corresponding messages and/or alerts. The chassis map is thus a graphical user interface that presents a simple visualization of the physical components installed within the chassis. Any physical component or peripheral device may be represented as an icon with status and messaging details. Moreover, the chassis map is web-based, thus providing a generic or agnostic solution that does not depend on hardware or software capabilities. Any computer, tablet, or even smartphone may download the chassis map using a software plugin or web-based application. The chassis map generates a complete and holistic virtual representation of the chassis and its components, thus visually pinpointing diagnostic and maintenance efforts.

### BRIEF DESCRIPTION OF THE DRAWINGS

It will be appreciated that for simplicity and clarity of illustration, elements illustrated in the Figures are not necessarily drawn to scale. For example, the dimensions of some elements may be exaggerated relative to other elements. Embodiments incorporating teachings of the present disclosure are shown and described with respect to the drawings herein, in which:

FIG. 1 is a block diagram illustrating an information handling system according to an embodiment of the present disclosure;

FIGS. 2-4 illustrate data collection, according to exemplary embodiments;

FIG. 5 illustrates alert data, according to exemplary embodiments;

FIGS. 6-8 illustrate visualizations, according to exemplary embodiments;

FIG. 9 illustrates client distribution, according to exemplary embodiments;

FIG. 10 illustrates a network-centric solution, according to exemplary embodiments;

FIG. 11 illustrates component details, according to exemplary embodiments; and

FIG. 12 is a flowchart illustrating a method or algorithm for visualizing the internal componentry operating within the information handling system, according to exemplary embodiments.

The use of the same reference symbols in different drawings indicates similar or identical items.

### DETAILED DESCRIPTION OF THE DRAWINGS

The following description in combination with the Figures is provided to assist in understanding the teachings disclosed herein. The description is focused on specific implementations and embodiments of the teachings, and is provided to assist in describing the teachings. This focus should not be interpreted as a limitation on the scope or applicability of the teachings.

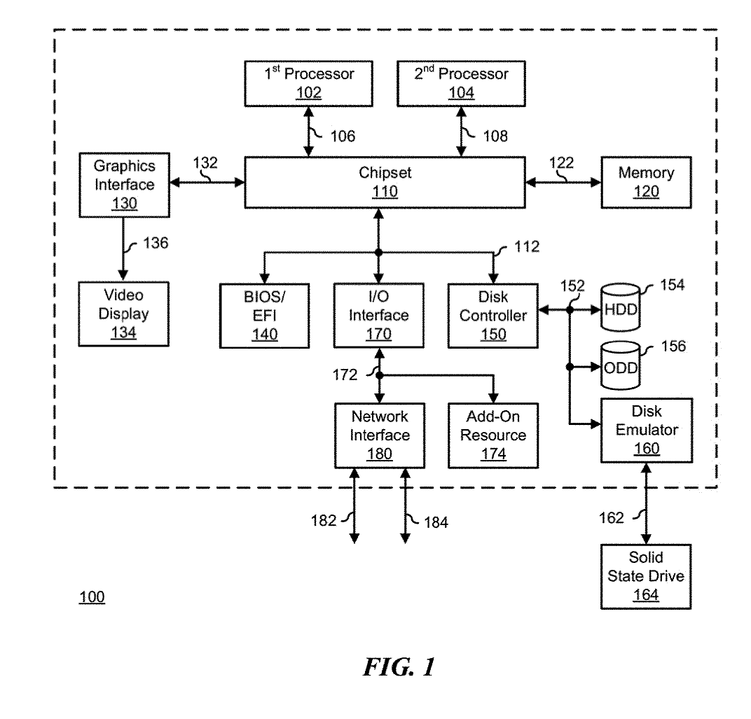

FIG. 1 illustrates a generalized embodiment of an information handling system 100, according to exemplary embodiments. For purpose of this disclosure the information handling system 100 can include any instrumentality or aggregate of instrumentalities operable to compute, classify, process, transmit, receive, retrieve, originate, switch, store, display, manifest, detect, record, reproduce, handle, or utilize any form of information, intelligence, or data for business, scientific, control, entertainment, or other purposes. For example, the information handling system 100 can be a personal computer, a laptop computer, a smart phone, a tablet device or other consumer electronic device, a network server, a network storage device, a switch router or other network communication device, or any other suitable device and may vary in size, shape, performance, functionality, and price. Further, the information handling system 100 can include processing resources for executing machine-executable code, such as a central processing unit (CPU), a programmable logic array (PLA), an embedded device such as a System-on-a-Chip (SoC), or other control logic hardware. The information handling system 100 can also include one or more computer-readable medium for storing machine-executable code, such as software or data. Additional components of the information handling system 100 can include one or more storage devices that can store machine-executable code, one or more communications ports for communicating with external devices, and various input and output (I/O) devices, such as a keyboard, a mouse, and a video display. The information handling system 100 can also include one or more buses operable to transmit information between the various hardware components.

The information handling system 100 can include devices or modules that embody one or more of the devices or modules described above, and operates to perform one or more of the methods described above. The information handling system 100 includes one or more processors (such as reference numerals 102 and 104), a chipset 110, a memory 120, a graphics interface 130, a basic input and output system/extensible firmware interface (BIOS/EFI) module 140, a disk controller 150, a disk emulator 160, an input/output (I/O) interface 170, and a network interface 180. Processor 102 is connected to chipset 110 via processor interface 106, and processor 104 is connected to chipset 110 via processor interface 108. Memory 120 is connected to chipset 110 via a memory bus 122. Graphics interface 130 is connected to chipset 110 via a graphics interface 132, and provides a video display output 136 to a video display 134. In a particular embodiment, the information handling system 100 includes separate memories that are dedicated to each of the processors 102 and 104 via separate memory interfaces. An example of the memory 120 includes random access memory (RAM) such as static RAM (SRAM), dynamic RAM (DRAM), non-volatile RAM (NV-RAM), or the like, read only memory (ROM), another type of memory, or a combination thereof.

BIOS/EFI module 140, disk controller 150, and I/O interface 170 are connected to chipset 110 via an I/O channel 112. An example of I/O channel 112 includes a Peripheral Component Interconnect (PCI) interface, a PCI-Extended (PCI-X) interface, a high-speed PCI-Express (PCIe) interface, another industry standard or proprietary communication interface, or a combination thereof. Chipset 110 can also include one or more other I/O interfaces, including an Industry Standard Architecture (ISA) interface, a Small Computer Serial Interface (SCSI) interface, an Inter-Integrated Circuit (I²C) interface, a System Packet Interface (SPI), a Universal Serial Bus (USB), another interface, or a combination thereof. BIOS/EFI module 140 includes BIOS/EFI code operable to detect resources within information handling system 100, to provide drivers for the resources, initialize the resources, and access the resources.

Disk controller 150 includes a disk interface 152 that connects the disk controller 150 to a hard disk drive (HDD) 154, to an optical disk drive (ODD) 156, and to disk emulator 160. An example of disk interface 152 includes an Integrated Drive Electronics (IDE) interface, an Advanced Technology Attachment (ATA) such as a parallel ATA (PATA) interface or a serial ATA (SATA) interface, a SCSI interface, a USB interface, a proprietary interface, or a combination thereof. Disk emulator 160 permits a solid-state drive 164 to be connected to information handling system 100 via an external interface 162. An example of external interface 162 includes a USB interface, an IEEE 1194 (Firewire) interface, a proprietary interface, or a combination thereof. Alternatively, solid-state drive 164 can be disposed within information handling system 100.

I/O interface 170 includes a peripheral interface 172 that connects the I/O interface to an add-on resource 174 and to network interface 180. Peripheral interface 172 can be the same type of interface as I/O channel 112, or can be a different type of interface. As such, I/O interface 170 extends the capacity of I/O channel 112 when peripheral interface 172 and the I/O channel are of the same type, and the I/O interface translates information from a format suitable to the I/O channel to a format suitable to the peripheral channel 172 when they are of a different type. Add-on resource 174 can include a data storage system, an additional graphics interface, a network interface card (NIC), a sound/video processing card, another add-on resource, or a combination thereof. Add-on resource 174 can be on a main circuit board, on separate circuit board or add-in card disposed within information handling system 100, a device that is external to the information handling system, or a combination thereof.

Network interface 180 represents a NIC disposed within the information handling system 100, on a main circuit board of the information handling system 100, integrated onto another component such as chipset 110, in another suitable location, or a combination thereof. Network interface device 180 includes network channels 182 and 184 that provide interfaces to devices that are external to information handling system 100. In a particular embodiment, network channels 182 and 184 are of a different type than peripheral channel 172 and network interface 180 translates information from a format suitable to the peripheral channel to a format suitable to external devices. An example of network channels 182 and 184 includes InfiniBand channels, Fibre Channel channels, Gigabit Ethernet channels, proprietary channel architectures, or a combination thereof. Network channels 182 and 184 can be connected to external network resources (not illustrated). The network resource can include another information handling system, a data storage system, another network, a grid management system, another suitable resource, or a combination thereof.

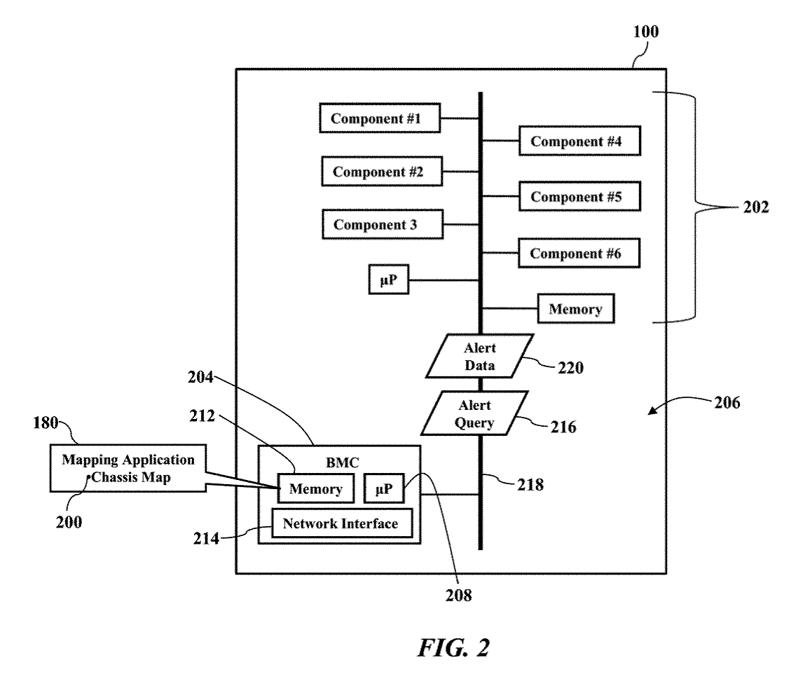

FIGS. 2-4 are block diagrams illustrating data collection, according to exemplary embodiments. Here the information handling system (“IHS”) 100 generates a chassis map 200 representing its internal components 202. The information handling system 100 may have a baseboard management controller (or “BMC”) 204 that inventories the internal components 202 installed within a chassis 206. For example, the baseboard management controller 204 has a dedicated processor 208 that executes a mapping application 210 stored in an internal memory device 212. The baseboard management controller 204 also has one or more dedicated network interfaces 214. The mapping application 210 includes code or instructions that cause the baseboard management controller 204 to send an alert query 216 to the internal components 202 installed within the chassis 206. While the alert query 216 may communicate via any mechanism, FIG. 2 illustrates a local bus 218 coupling the internal components 202 to the baseboard management controller 204. If any of the internal components 202 is experiencing a problem, error, or alert, the internal component 202 responds with its corresponding alert data 220. The alert data 220 represents any data, information, or message worthy of threshold alerting. The alert data 220 usually exceeds some threshold comparison (such as temperature, value, or time).

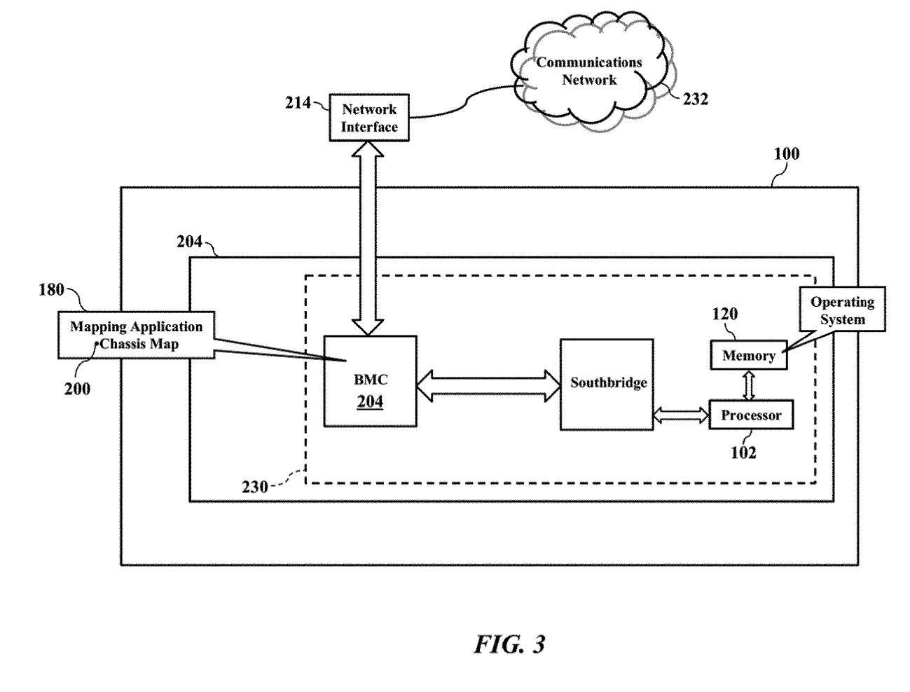

FIG. 3 further illustrates the baseboard management controller 204. The baseboard management controller 204 allows the information handling system (“IHS”) 100 to be remotely managed, perhaps according to the Intelligent Platform Management Interface (or “IPMI”) specification. That is, the information handling system 100 has a motherboard 230 comprising the chipset 110. However, the information handling system 100 may also have the separate baseboard management controller 204. As those of ordinary skill in the art understand, the baseboard management controller 204 interfaces with the motherboard 230 to provide side-band and out-of-band remote management of the information handling system 100. The baseboard management controller 204 has one or more physical communications links and interfaces to the motherboard 230, thus allowing the baseboard management controller 204 to process messages according to the IPMI specification. The baseboard management controller 204 may thus monitor and report the functions and performance of the information handling system 100 via the separate network interface 214 to a communications network 232. The IPMI specification is generally well known and thus need not be explained in detail. The baseboard management controller 204 may thus inventory the internal components 202 and/or generate the chassis map 200, as explained herein.

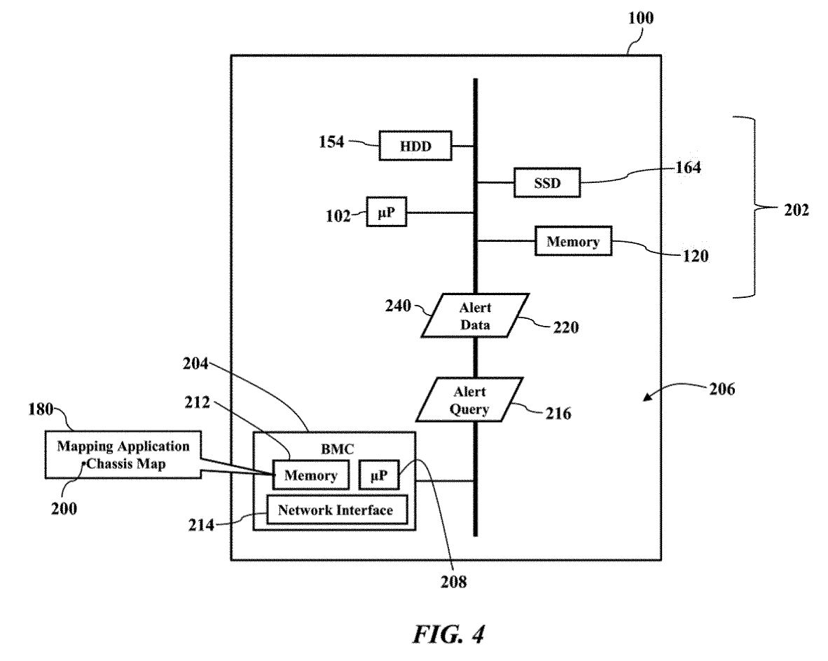

FIG. 4 illustrates component-level reporting. While there may be many internal components 202 within the chassis 206 (as explained with reference to FIG. 1), FIG. 4 only illustrates the internal components 202 though familiar to most readers. Suppose the processor 102 is experiencing a problem and generates its corresponding alert data 220. The processor 102 generates a query response 240 that includes the alert data 220 describing the problem. The alert data 220 communicates via any networking interface (such as PCI, PCI-X, PCIe, I²C, or USB) to the baseboard management controller 204. Exemplary embodiments may further collect the alert data 220 generated by the memory 120, the hard disk drive (“HDD”) 154, and/or the solid-state drive “SSD”) 164. In plain words, if any of the internal components 202 is experiencing an alert or fault, the corresponding component-level alert data 220 is retrieved.

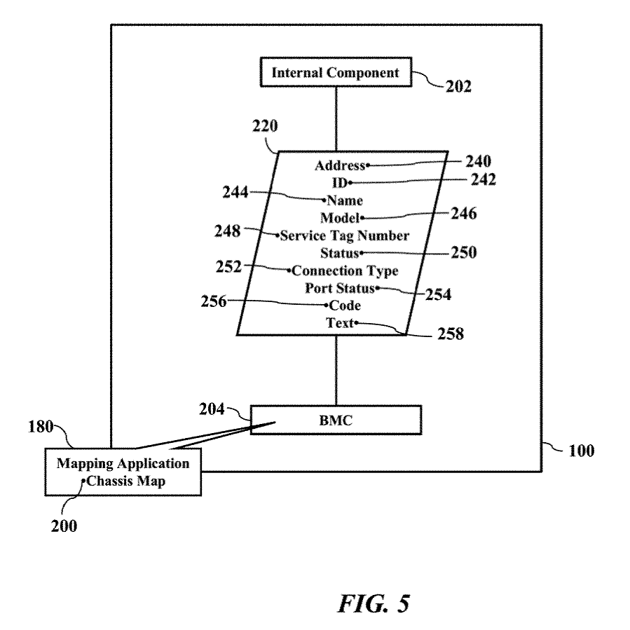

FIG. 5 further illustrates the alert data 220, according to exemplary embodiments. The alert data 220 describes any information associated with the internal component 202. For example, the alert data 220 may include a chassis address 240, a component identifier (“ID”) 242, a component name 244, a component model 246, a service tag number 248, a network connection status 250, network connection type 252 (e.g., PCI), and perhaps port status 254. Moreover, the alert data 220 may also describe any errors, conditions, or even normal operation of the internal component 202 (such as the CPU processor 102/104, the hard disk drive (“HDD”) 154, a power supply 251, and one or more cooling fans 253. If the internal component 202 has nothing to report (e.g., no faults or codes), then perhaps the alert data 220 indicates a normal operation. However, if a problem is detected, the alert data 220 may also include an alert description, such as an error or fault code 256 and a corresponding textual description 258. The mapping application 210 thus collects the alert data 220 generated by any of the internal components 202.

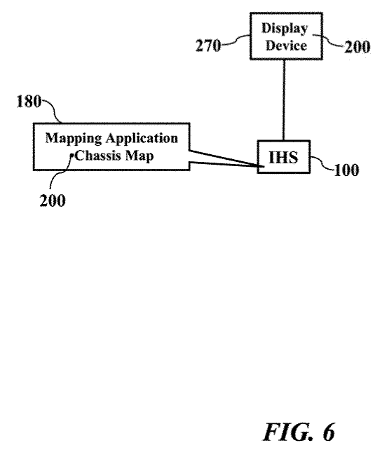

FIGS. 6-8 illustrate visualizations, according to exemplary embodiments. Once the information handling system 100 collects the alert data 220 (as explained with reference to FIGS. 2-5), exemplary embodiments create the chassis map 200 for display. FIG. 6 thus illustrates the information handling system (“IHS”) 100 displaying the chassis map 200 via a display device 270.

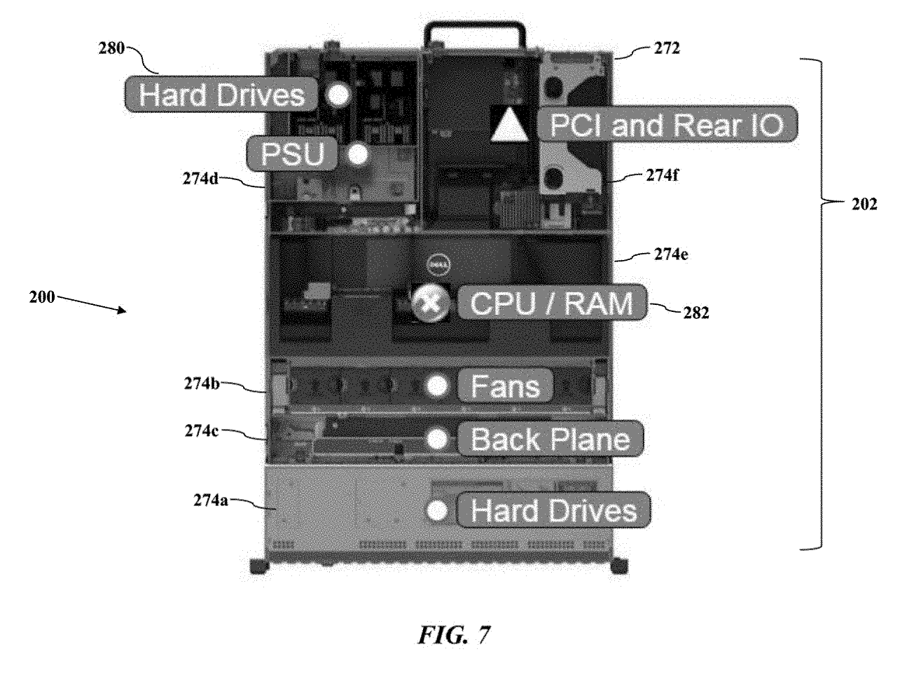

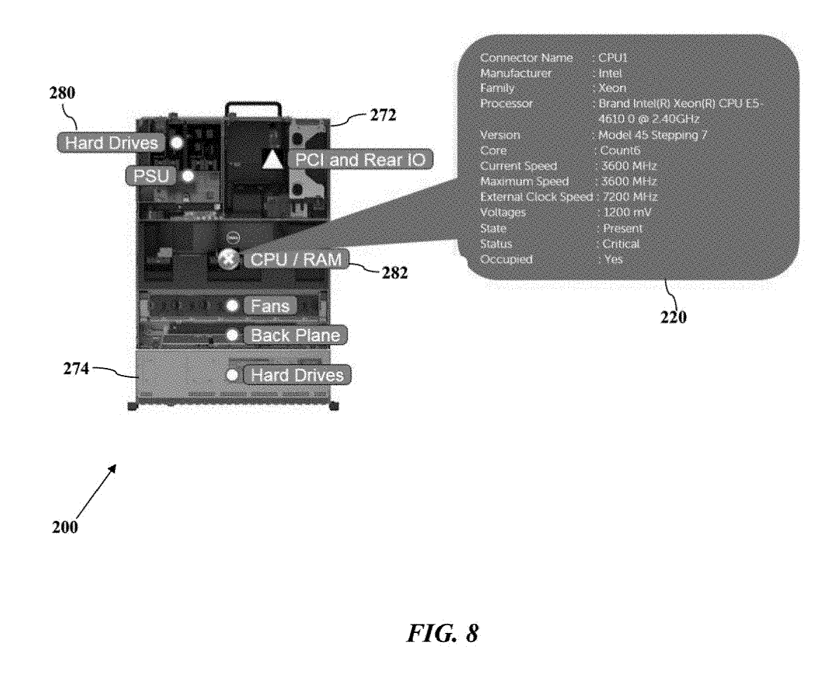

FIGS. 7-8 are screenshots of the chassis map 200 representing a virtual simulation 272 of the internal components 202 installed within the information handling system 100. Exemplary embodiments arrange one or more digital images (illustrated as reference numerals 274a-e) representing the internal components 202. The mapping application 210 may retrieve each digital image 274 that corresponds to any internal component 202. The mapping application 210 may then assemble or arrange the multiple digital images 274a-e as the chassis map 200. Each digital image 274 is thus oriented and located in the virtual simulation 272 to match the physical location of the internal component 202 within the information handling system 100. The chassis map 200 thus virtually reproduces or replicates the information handling system 100 along with the internal components 202.

Visual aids may also be incorporated. The virtual simulation 272 represents each internal component 202 with its corresponding digital image 274. Moreover, the virtual simulation 272 may also retrieve and display a textual description 280 of the corresponding internal component 202, perhaps based on the alert data 220 (as explained with reference to FIG. 5). However, should any internal component 202 report a problem or error, exemplary embodiments may generate and display an alert icon 282 or other graphical indication. For simplicity, FIG. 7 merely illustrates an iconic “X” to indicate the “CPU/RAM” is reporting an alert. FIG. 8 illustrates display of the corresponding alert data 220. That is, the alert icon 282 may be a graphical control that performs an action, such as formatting the alert data 220 for overlaid display in the virtual simulation 272. A user may thus place a cursor or otherwise select the alert icon 282 to display the corresponding alert data 220. The user may thus quickly and easily observe the component details that greater explain the alert.

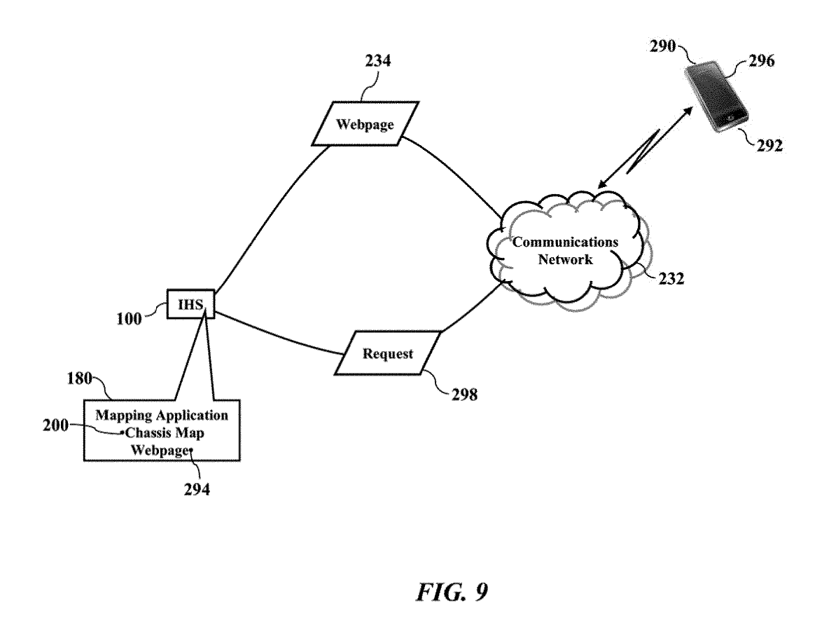

FIG. 9 illustrates client distribution, according to exemplary embodiments. Once the information handling system (“IHS”) 100 generates the chassis map 200, exemplary embodiments may distribute the chassis map 200 to any requesting client device 290. FIG. 9 illustrates the requesting client device 290 as a mobile smartphone 292, which most readers are thought familiar. The requesting client device 290, however, may be any processor-controlled device, such as an enterprise server 293 associated with enterprise customers. The information handling system 100, for example, may generate or package the chassis map 200 as a webpage 294. The requesting client device 290 may call or invoke a web browser application 296 and send a request 298 to the information handling system 100 via the communications network 232 (such as the Internet). The request 298 includes or specifies information that identifies the information handling system 100. The request 298, for example, may include an identifier that uniquely identifies the information handling system 100 (such as the chassis 206 (illustrated in FIG. 2) or an IP address). The requesting client device 290 sends the request 298 to a network address (e.g., Internet Protocol address) associated with the information handling system 100. When the information handling system 100 receives the request 298, the information handling system 100 generates and/or retrieves the chassis map 200. The information handling system 100 may thus send the webpage 294 via the communications network 232 to any destination, such as a network address (e.g., Internet Protocol address) associated with requesting client device 290. The requesting client device 290 calls or invokes the web browser application 296 to process the webpage 294 for display via a display device (such as a touch screen). A user of the requesting client device 290 may thus visually inspect the chassis map 200.

Exemplary embodiments thus present an elegant, web-based solution. Exemplary embodiments generate the chassis map 200 that virtually replicates the information handling system 100, including the digital images 274 representing the internal components 202. The alert data 220 may be collected directly from the internal components 202, thus ensuring correct and fresh data. The internal components 202 may thus be processed in real time for a detailed, holistic view of the actual internal components 202. Exemplary embodiments may even graphically reveal the alert data 220 associated with any internal component 202.

Exemplary embodiments are agnostic. Because exemplary embodiments present a web-based solution, the virtual simulation 272 of the information handling system 100 is executed in a device-generic environment. That is, exemplary embodiments are agnostic to the hardware and software capabilities of the information handling system 100. Exemplary embodiments may utilize web based JavaScript, Canvas technology, and/or an application programming interface (“API”) to build a software plugin. Exemplary embodiments may use the alert data 220 to draw or illustrate the internal components 202 at runtime. If the alert data 220 is formatted according to a format, then the alert data 220 may be collected from any internal component 202 without regard for manufacturer and hardware/software capabilities. Exemplary embodiments may also use markup data to highlight any simulated internal component 202, connection, and/or alert data 220. Moreover, runtime markup may help ensure the virtual simulation 272 of the information handling system 100 remains intact, thus keeping the visual resolution correct even if a user zooms in or out for detail.

Runtime execution is beneficial. Exemplary embodiments may be triggered at runtime using available alerts. The virtual simulation 272 of the information handling system 100 may be easily customized using configuration properties. Exemplary embodiments thus visualize actual alerts generated by an internal component 202 operating within the information handling system 100. Once the alert data 220 is obtained, exemplary embodiments may use the alert data 220 to visually map the corresponding digital image 274. Because exemplary embodiments are web-based, a user may even select a particular digital image 274 or its associated alert data 220 and make changes (such as escalating an alert from Warning to Critical). The chassis map 200 may even be customized to a particular theme using browser viewing options and schemes.

Exemplary embodiments may also be used offline. Once the chassis map 200 is generated, exemplary embodiments may store or archive the chassis map 200 for later retrieval and use. That is, exemplary embodiments may provide or recall the chassis map 200 for offline visual reference.

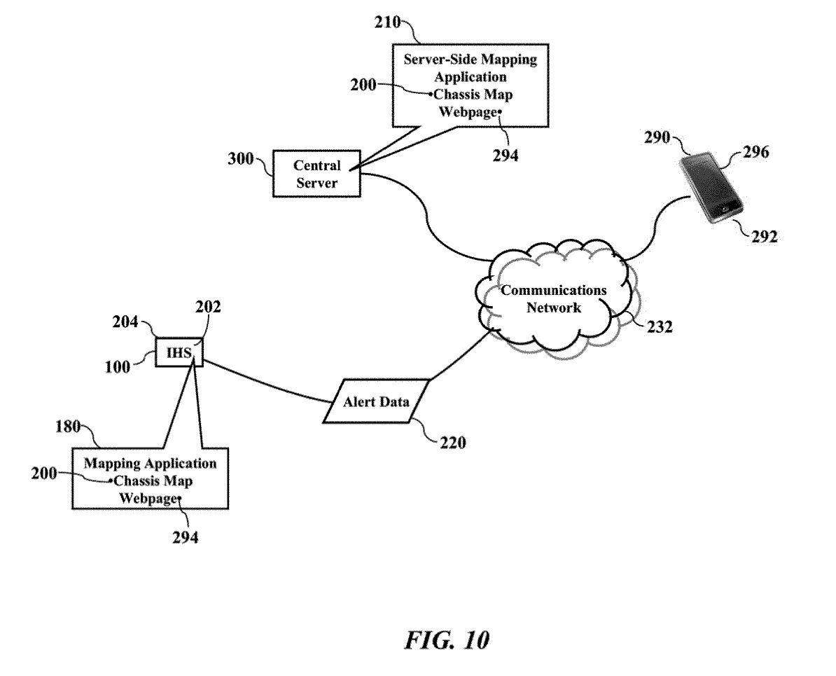

FIG. 10 illustrates a network-centric solution, according to exemplary embodiments. Here the information handling system 100 and/or the baseboard management controller 204 may collect and report the alert data 220 to a central server 300. For example, when the alert data 220 is received, the information handling system 100 and/or the baseboard management controller 204 may send or forward the alert data via the communications network 232 to the network address (e.g., an Internet Protocol address) associated with the central server 300. The central server 300 may thus have an internal processor and memory device (not shown for simplicity) that executes a server-side version of the mapping application 210. The server-side version of the mapping application 210 causes the central server 300 to generate the chassis map 200 based on the alert data 220 sent from the information handling system 100 and/or the baseboard management controller 204. The central server 300 may then generate or package the chassis map 200 as the webpage 294 for distribution via the communications network 232 to any destination (such as the requesting client device 290 and/or the enterprise server 293).

Exemplary embodiments may also be remotely provided. Because the solution is web-based, the baseboard management controller 204 and/or the central server 300 may be accessible from any networked location. The solution thus does not need to be installed on the central server 300 or the requesting client device 290 and/or the enterprise server 293, the chassis map 200, instead is based on the alert data 220 collected from the internal components 202. The chassis map 200 is thus available for remote viewing. This remote capability is very useful for diagnostic assessment in the event of a failure within the internal components 202.

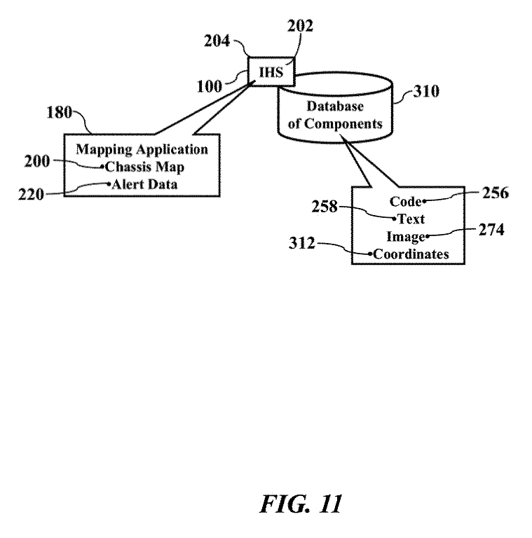

FIG. 11 illustrates component details, according to exemplary embodiments. Once the alert data 220 is received, exemplary embodiments may determine additional data that helps generate the chassis map 200. For example, once any of the alert data 220 is determined, exemplary embodiments may query a database 310 of components. The database 310 of components is a repository of detailed hardware and/or software information associated with different components. The database 310 of components may thus have entries that electronically associate models, serial numbers, and/or component identifiers to their corresponding hardware and software details and capabilities. The database 310 of components may be preloaded or preconfigured with a single manufacturer's products or multiple manufacturers' products. Regardless, exemplary embodiments may query the database 310 of components for any field or data contained within the alert data 220. The database 310 of components may thus identify any particular component details that are electronically associated with the alert data 220. For example, the database 310 of components database 310 of components may reveal the error code 256 and/or the textual description 258 associated with the alert data 220 (as illustrated with reference to FIG. 5). The database 310 of components may also identify the digital image 274 (such as a jpeg) that is electronically associated with the alert data 220 (such as a manufacturer and model number). The database 310 of components may also identify display coordinates 312 for accurately locating the digital image 274 within the chassis map 200.

Exemplary embodiments may then generate the chassis map 200. Once the digital image 274 is fetched and the display coordinates 312 are known, exemplary embodiments may use markup data to highlight any alert data 220 that corresponds to the internal component 202. Exemplary embodiments, for example, may thus graphically emphasize the digital image 274 that corresponds to the actual, physical internal component 202 reporting the alert data 220. When the chassis map 200 is drawn, any alert data 220 that is virtually represented may be marked up to aid visualization, diagnosis, and fault identification. Each digital image 274 is retrieved and incorporated into the chassis map 200. Because exemplary embodiments are web-based, a user may click or otherwise select any digital image 274 to obtain the detailed alert data 220. Indeed, a user may even select a particular digital image 274 and edit the corresponding textual alert data 220. The user may also click and edit colors, the component name, and other visualization features.

Exemplary embodiments may also include a graphical toolbar. The toolbar may have graphical icons and/or controls for predefined actions. For example, iconic options may allow a user to zoom in or out on a particular internal component 202. A search option may allow the user to search for particular text and generate a search result of the alert data 220 containing matching text. Exemplary embodiments may also highlight any digital image 274 associated with the matching text. Other actions may disable a particular internal component, merely by selecting its corresponding digital image 274 (or the webpage 294) and changing a status field or option. Another option may save the chassis map 200 as image data or even a portable document format (PDF) file for offline usage. Graphical controls may allow a user to place a graphical cursor and/or select a particular control to perform a predefined action. The user may thus zoom in or out on the digital image 274, search for text displayed within the webpage 294, and even search fields or entries within the alert data 220. Search results may be highlighted for ease of reference. Exemplary embodiments may also highlight any digital image 274 experiencing an alert or upon a user's selection.

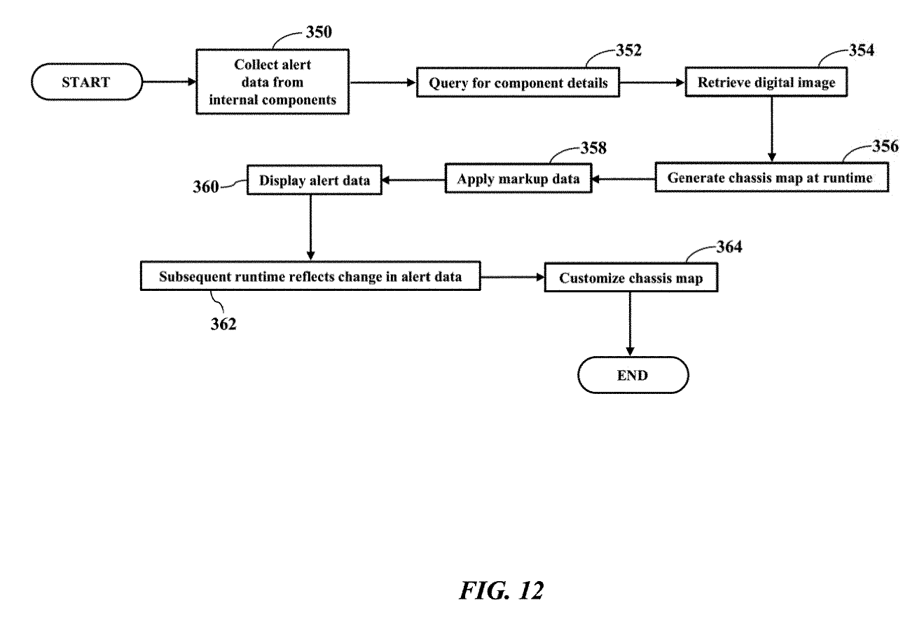

FIG. 12 is a flowchart illustrating a method or algorithm for visualizing the internal componentry xx operating within the information handling system 100, according to exemplary embodiments. The internal components 202 are queried to collect the alert data 220 (Block 350). The database 310 of components is queried for componentry details (Block 352), and the digital image 274 is retrieved (Block 354). The chassis map 200 is generated at runtime (Block 356) and markup data is applied (Block 358). The alert data 220 is displayed in the chassis map 200 (Block 360). Any change in the alert data 220 will be reflected at a subsequent runtime (Block 362). The chassis map 200 is customized according to user selections/preferences (Block 364).

Exemplary embodiments may packetize. The information handling system 100, the baseboard management controller 204, the requesting client device 290, and/or the central server 300 may interface with the communications network 232 (such as the Internet). Messages and data may be packetized into packets of data according to a packet protocol, such as the Internet Protocol. The packets of data contain bits or bytes of data describing the contents, or payload, of a message. A header of each packet of data may contain routing information identifying an origination address and/or a destination address. There are many different known packet protocols, and the Internet Protocol is widely used, so no detailed explanation is needed.

Exemplary embodiments may be applied regardless of networking environment. Exemplary embodiments may be easily adapted to stationary or mobile devices having cellular, WI-FI®, near field, and/or BLUETOOTH® capability. Exemplary embodiments may be applied to devices utilizing any portion of the electromagnetic spectrum and any signaling standard (such as the IEEE 802 family of standards, GSM/CDMA/TDMA or any cellular standard, and/or the ISM band). Exemplary embodiments, however, may be applied to any processor-controlled device operating in the radio-frequency domain and/or the Internet Protocol (IP) domain. Exemplary embodiments may be applied to any processor-controlled device utilizing a distributed computing network, such as the Internet (sometimes alternatively known as the “World Wide Web”), an intranet, the local-area network (LAN), and/or a wide-area network (WAN). Exemplary embodiments may be applied to any processor-controlled device utilizing power line technologies, in which signals are communicated via electrical wiring. Indeed, exemplary embodiments may be applied regardless of physical componentry, physical configuration, or communications standard(s).

While the computer-readable medium is shown to be a single medium, the term “computer-readable medium” includes a single medium or multiple media, such as a centralized or distributed database, and/or associated caches and servers that store one or more sets of instructions. The term “computer-readable medium” shall also include any medium that is capable of storing, encoding, or carrying a set of instructions for execution by a processor or that cause a computer system to perform any one or more of the methods or operations disclosed herein.

In a particular non-limiting, exemplary embodiment, the computer-readable medium can include a solid-state memory such as a memory card or other package that houses one or more non-volatile read-only memories. Further, the computer-readable medium can be a random access memory or other volatile re-writable memory. Additionally, the computer-readable medium can include a magneto-optical or optical medium, such as a disk or tapes or other storage device to store information received via carrier wave signals such as a signal communicated over a transmission medium. Furthermore, a computer readable medium can store information received from distributed network resources such as from a cloud-based environment. A digital file attachment to an e-mail or other self-contained information archive or set of archives may be considered a distribution medium that is equivalent to a tangible storage medium. Accordingly, the disclosure is considered to include any one or more of a computer-readable medium or a distribution medium and other equivalents and successor media, in which data or instructions may be stored.

In the embodiments described herein, an information handling system includes any instrumentality or aggregate of instrumentalities operable to compute, classify, process, transmit, receive, retrieve, originate, switch, store, display, manifest, detect, record, reproduce, handle, or use any form of information, intelligence, or data for business, scientific, control, entertainment, or other purposes. For example, an information handling system can be a personal computer, a consumer electronic device, a network server or storage device, a switch router, wireless router, or other network communication device, a network connected device (cellular telephone, tablet device, etc.), or any other suitable device, and can vary in size, shape, performance, price, and functionality.

The information handling system can include memory (volatile (e.g. random-access memory, etc.), nonvolatile (read-only memory, flash memory etc.) or any combination thereof), one or more processing resources, such as a central processing unit (CPU), a graphics processing unit (GPU), hardware or software control logic, or any combination thereof. Additional components of the information handling system can include one or more storage devices, one or more communications ports for communicating with external devices, as well as, various input and output (I/O) devices, such as a keyboard, a mouse, a video/graphic display, or any combination thereof. The information handling system can also include one or more buses operable to transmit communications between the various hardware components. Portions of an information handling system may themselves be considered information handling systems.

When referred to as a “device,” a “module,” or the like, the embodiments described herein can be configured as hardware. For example, a portion of an information handling system device may be hardware such as, for example, an integrated circuit (such as an Application Specific Integrated Circuit (ASIC), a Field Programmable Gate Array (FPGA), a structured ASIC, or a device embedded on a larger chip), a card (such as a Peripheral Component Interface (PCI) card, a PCI-express card, a Personal Computer Memory Card International Association (PCMCIA) card, or other such expansion card), or a system (such as a motherboard, a system-on-a-chip (SoC), or a stand-alone device).

The device or module can include software, including firmware embedded at a device, such as a Pentium class or PowerPC™ brand processor, or other such device, or software capable of operating a relevant environment of the information handling system. The device or module can also include a combination of the foregoing examples of hardware or software. Note that an information handling system can include an integrated circuit or a board-level product having portions thereof that can also be any combination of hardware and software.

Devices, modules, resources, or programs that are in communication with one another need not be in continuous communication with each other, unless expressly specified otherwise. In addition, devices, modules, resources, or programs that are in communication with one another can communicate directly or indirectly through one or more intermediaries.

Although only a few exemplary embodiments have been described in detail herein, those skilled in the art will readily appreciate that many modifications are possible in the exemplary embodiments without materially departing from the novel teachings and advantages of the embodiments of the present disclosure. Accordingly, all such modifications are intended to be included within the scope of the embodiments of the present disclosure as defined in the following claims. In the claims, means-plus-function clauses are intended to cover the structures described herein as performing the recited function and not only structural equivalents, but also equivalent structures.

What is claimed is:

1. A method comprising:
sending, by an information handling system, a query to an internal component operating within the information handling system, the query requesting alert data associated with an alert;
receiving, by the information handling system, the alert data reported by the internal component to indicate the alert; and
generating, by the information handling system, a chassis map in response to the alert data, the chassis map including a virtual simulation of the internal component operating within the information handling system.

2. The method of claim 1, further comprising displaying the alert data reported by the internal component in the chassis map.

3. The method of claim 1, further comprising retrieving a component image associated with the internal component operating within the information handling system.

4. The method of claim 3, further comprising incorporating the component image into the chassis map.

5. The method of claim 3, further comprising visually highlighting the component image incorporated into the chassis map.

6. The method of claim 1, further comprising generating a webpage representing the chassis map.

7. The method of claim 1, further comprising saving the chassis map for at least one online usage and offline usage.

8. An information handling system, comprising:
a hardware processor; and
a memory device accessible to the hardware processor and storing instructions that when executed cause the hardware processor to perform operations, the operations comprising:
sending queries to internal components operating within the information handling system, the queries requesting alert data associated with alerts;
receiving the alert data reported by an internal component of the internal components, the alert data indicating an alert of the alerts; and
generating a chassis map in response to the alert data, the chassis map comprising a virtual simulation of the internal component operating within the information handling system that is indicating the alert.

9. The information handling system of claim 8, wherein the operations further comprise generating a webpage comprising the virtual simulation of the internal component operating within the information handling system.

10. The information handling system of claim 9, wherein the operations further comprise sending the webpage to a destination.

11. The information handling system of claim 8, wherein the operations further comprise displaying the alert data reported by the internal component in the chassis map.

12. The information handling system of claim 8, wherein the operations further comprise retrieving a component image associated with the internal component operating within the information handling system.

13. The information handling system of claim 12, wherein the operations further comprise incorporating the component image into the chassis map.

14. The information handling system of claim 12, wherein the operations further comprise visually highlighting the component image incorporated into the chassis map.

15. A memory device storing instructions that when executed cause a hardware processor to perform operations, the operations comprising:
sending queries to internal components operating within the information handling system, the queries requesting alert data associated with alerts;
receiving the alert data reported by an internal component of the internal components, the alert data indicating an alert of the alerts; and
generating a chassis map in response to the alert data, the chassis map comprising a virtual simulation of the internal component operating within the information handling system that is indicating the alert.

16. The memory device of claim 15, wherein the operations further comprise generating a webpage comprising the virtual simulation of the internal component operating within the information handling system.

17. The memory device of claim 16, wherein the operations further comprise sending the webpage to a destination.

18. The memory device of claim 15, wherein the operations further comprise displaying the alert data reported by the internal component in the chassis map.

19. The memory device of claim 15, wherein the operations further comprise retrieving a component image associated with the internal component operating within the information handling system.

20. The memory device of claim 15, wherein the operations further comprise incorporating the component image into the chassis map.
